(19) United States
(12) Patent Application Publication
(10) Pub. No.: US 2019/0118425 A1
(43) Pub. Date: Apr. 25, 2019

(54) POLY(PHENYLENE ETHER) MOLDING METHOD AND ARTICLES, AND METHOD OF INCREASING POLY(PHENYLENE ETHER) CRYSTALLINITY

(71) Applicant: SABIC GLOBAL TECHNOLOGIES B.V., Bergen op Zoom (NL)

(72) Inventors: Yousof Mustafa Ghazzawi, Riyadh (SA); Zahir Bashir, Riyadh (SA)

(21) Appl. No.: 16/302,696

(22) PCT Filed: May 11, 2017
(86) PCT No.: PCT/IB2017/052771

§ 371 Date: Nov. 19, 2018

Related U.S. Application Data
(60) Provisional application No. 62/340,565, filed on May 24, 2016.

(51) Int. Cl. B29C 43/00; C08L 71/12; C08K 3/013

(52) U.S. Cl. CPC B29C 43/006; B29C 43/003; B29K 2071/12; C08K 3/013; C08L 71/12

(57) ABSTRACT

A composition containing a semicrystalline poly(2,6-dimethyl-1,4-phenylene ether) having a glass transition temperature of 205 to 225° C. can be compression molded under conditions that include a molding temperature substantially below the glass transition temperature. In some cases, the crystallinity of the poly(2,6-dimethyl-1,4-phenylene ether) increases substantially during molding, even though the molding temperature is below the glass transition temperature. Also described are articles formed by the molding method, articles in which the poly(2,6-dimethyl-1,4-phenylene ether) has a crystallinity of at least 5 weight percent, and a method of increasing the crystallinity of poly(2,6-dimethyl-1,4-phenylene ether).

### BACKGROUND OF THE INVENTION

Poly(2,6-dimethyl-1,4-phenylene ether) is a type of plastic valued for its heat resistance, stiffness, and impact strength, among other properties. Poly(2,6-dimethyl-1,4-phenylene ether) is typically manufactured by a process that includes isolation by precipitation from a solvent/antisolvent mixture. This precipitation step yields an essentially amorphous (noncrystalline) product, although some variations in precipitation conditions can produce a small degree of crystallinity.

Because poly(2,6-dimethyl-1,4-phenylene ether) exhibits thermal instability at temperatures required for melt processing, it is typically blended with a lower-melting plastic, such as polystyrene, to allow for melt processing at lower temperature. One consequence of such blending is that any small amount of crystallinity in the poly(2,6-dimethyl-1,4-phenylene ether) becomes amorphous.

It has therefore been difficult to form articles from unblended poly(2,6-dimethyl-1,4-phenylene ether). It has also been difficult to form articles in which the poly(2,6-dimethyl-1,4-phenylene ether) exhibits a substantial degree of crystallinity, which would provide greater solvent resistance, greater hardness, and greater wear resistance relative to articles containing amorphous poly(2,6-dimethyl-1,4-phenylene ether).

### BRIEF SUMMARY OF EMBODIMENTS OF THE INVENTION

One embodiment is a method of forming an article, comprising: adding a molding composition comprising a semicrystalline poly(2,6-dimethyl-1,4-phenylene ether) powder to a cavity of a compression mold; wherein the semicrystalline poly(2,6-dimethyl-1,4-phenylene ether) powder has a crystallinity of at least 1 weight percent based on the total weight of the semicrystalline poly(2,6-dimethyl-1,4-phenylene ether) powder, and a glass transition temperature of 205 to 225° C.; and compressing the molding composition in the cavity at a compression temperature and a compression pressure for a period of 1 to 60 minutes to form the article; wherein the compression temperature is 130° C. to a temperature 5° C. less than the glass transition temperature of the semicrystalline poly(2,6-dimethyl-1,4-phenylene ether) powder; and wherein the compression pressure is 1 to 500 megapascals.

Another embodiment is an article formed by the method in any of its variations.

Another embodiment is an article comprising a composition comprising, based on the weight of the composition, 95 to 100 weight percent of poly(2,6-dimethyl-1,4-phenylene ether), and 0 to 5 weight percent of an additive selected from the group consisting of stabilizers, mold release agents, lubricants, processing aids, nucleating agents, UV blockers, dyes, pigments, antioxidants, antistatic agents, metal deactivators, and combinations thereof; wherein the poly(2,6-dimethyl-1,4-phenylene ether) has a crystallinity of at least 5 weight percent, based on the weight of the poly(2,6-dimethyl-1,4-phenylene ether).

Another embodiment is a method of increasing the crystallinity of a poly(2,6-dimethyl-1,4-phenylene ether), the method comprising: exposing a poly(2,6-dimethyl-1,4-phenylene ether) to a temperature of 130 to 200° C. and a pressure of 1 to 500 megapascals for a time of 1 to 60 minutes; wherein prior to said exposing, the poly(2,6-dimethyl-1,4-phenylene ether) has a crystallinity of at least 1 weight percent.

These and other embodiments are described in detail below.

### BRIEF DESCRIPTION OF THE DRAWINGS

FIG. 1 is a differential scanning calorimetry (DSC) thermogram for a poly(2,6-dimethyl-1,4-phenylene ether) powder.

FIG. 2 is a DSC thermogram for poly(2,6-dimethyl-1,4-phenylene ether) from an article molded at 150° C.

FIG. 3 is a DSC thermogram for poly(2,6-dimethyl-1,4-phenylene ether) from an article molded at 170° C.

FIG. 4 is a DSC thermogram for poly(2,6-dimethyl-1,4-phenylene ether) from an article molded at 240° C.

### DETAILED DESCRIPTION OF THE INVENTION

The present inventors have determined that particular conditions can be used to compression mold articles from a poly(2,6-dimethyl-1,4-phenylene ether)-containing composition. The process starts with a composition that includes a poly(2,6-dimethyl-1,4-phenylene ether) powder having at least 1 weight percent crystallinity, and includes heating the poly(2,6-dimethyl-1,4-phenylene ether) powder to a temperature of at least 130° C. but no greater than 5° C. below the glass transition temperature of the poly(2,6-dimethyl-1,4-phenylene ether), which is in the range 205 to 225° C. In some cases, the process yields a molded article in which the poly(2,6-dimethyl-1,4-phenylene ether) has a higher crystallinity than the starting poly(2,6-dimethyl-1,4-phenylene ether) powder, despite the molding temperature having been maintained substantially below the glass transition temperature of the starting poly(2,6-dimethyl-1,4-phenylene ether).

One embodiment is a method of forming an article, comprising: adding a molding composition comprising a semicrystalline poly(2,6-dimethyl-1,4-phenylene ether) powder to a cavity of a compression mold; wherein the semicrystalline poly(2,6-dimethyl-1,4-phenylene ether) powder has a crystallinity of at least 1 weight percent based on the total weight of the semicrystalline poly(2,6-dimethyl-1,4-phenylene ether) powder, and a glass transition temperature of 205 to 225° C.; and compressing the molding composition in the cavity at a compression temperature and a compression pressure for a period of 1 to 60 minutes to form the article; wherein the compression temperature is 130° C. to a temperature 5° C. less than the glass transition temperature of the semicrystalline poly(2,6-dimethyl-1,4-phenylene ether) powder; and wherein the compression pressure is 1 to 500 megapascals.

The method forms an article by compression molding. Methods and apparatuses for compression molding are known in the art. The present method is distinguished from art-known compression molding methods by its use of a molding composition that includes semicrystalline poly(2,6-dimethyl-1,4-phenylene ether). Poly(2,6-dimethyl-1,4-phenylene ether) is a homopolymer of 2,6-dimethylphenol. Poly(2,6-dimethyl-1,4-phenylene ether) has a plurality of repeat units having the structure

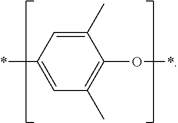

Depending on how it is synthesized, poly(2,6-dimethyl-1,4-phenylene ether) can further include repeat units in which one of the methyl groups is substituted with an amino group (e.g., n-butylamino or di-n-butylamino), and/or two repeat units joined tail-to-tail, as shown below,

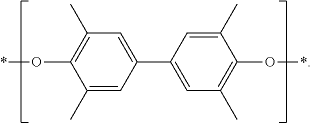

The poly(2,6-dimethyl-1,4-phenylene ether) powder contained in the molding composition is semicrystalline. As used herein, the term semicrystalline means having crystallinity of at least 1 weight percent, based on the weight of the semicrystalline poly(2,6-dimethyl-1,4-phenylene ether) powder. Within this limit, the crystallinity can be 1 to 90 weight percent, or 1 to 50 weight percent, or 1 to 30 weight percent, or 1 to 20 weight percent. Weight percent crystallinity can be determined using differential scanning calorimetry using a heating rate of 10° C. per minute, according to ASTM D3418-15, and comparing the heat of fusion so derived to the heat of fusion of a poly(2,6-dimethyl-1,4-phenylene ether) single crystal. S. Orikiri, “Single Crystals of Poly(2,6-dimethylphenylene Oxide)”, Journal of Polymer Science: Part A-2, 1972, volume 10, pages 1167-1170.

Methods of forming semicrystalline poly(2,6-dimethyl-1,4-phenylene ether) are known in the art. See, for example, U.S. Pat. No. 3,960,811 to Bennett et al., issued 1 Jun. 1976; S. Orikiri, “Single Crystals of Poly(2,6-dimethylphenylene Oxide)”, Journal of Polymer Science: Part A-2, 1972, volume 10, pages 1167-1170; W. Wenig et al., “Morphological Studies of Semicrystalline Poly(2,6-dimethylphenylene oxide)”, Macromolecules, 1976, volume 9, pages 253-257; E. Turska et al., “Liquid-induced crystallization of poly(2,6-dimethyl-1,4-phenylene ether)”, Polymer, 1978, volume 19, issue 1, pages 81-84; and W. R. Burghardt et al. “Glass transition, crystallization and thermoreversible gelation in ternary PPO solutions; relationship to asymmetric membrane formation”, Polymer, 1987, volume 28, issue 12, pages 2085-2092.

The semicrystalline poly(2,6-dimethyl-1,4-phenylene ether) powder has a glass transition temperature of 205 to 225° C. as determined by differential scanning calorimetry using a heating rate of 10° C. per minute. Within this range, the glass transition temperature can be 210 to 220° C.

In some embodiments, the poly(2,6-dimethyl-1,4-phenylene ether) powder has an intrinsic viscosity of 0.2 to 1.0 deciliter/gram, measured by Ubbelohde viscometer at 25° C. in chloroform. Within this range, the intrinsic viscosity can be 0.3 to 0.7 deciliter/gram, or 0.35 to 0.6 deciliter/gram.

The semicrystalline poly(2,6-dimethyl-1,4-phenylene ether) is in powder form. In some embodiments, the poly(2,6-dimethyl-1,4-phenylene ether) powder has a number-average mean particle size of 0.5 to 800 micrometers. Within this range, the number-average mean particle size can be 10 to 1,000 micrometers, or 50 to 500 micrometers, or 50 to 300 micrometers. Number-average mean particle size can be determined by laser diffraction techniques using commercially available equipment (e.g., the Malvern Mastersizer 3000 laser diffraction particle size analyzer).

In some embodiments, the molding composition comprises at least 50 weight percent of the semicrystalline poly(2,6-dimethyl-1,4-phenylene ether) powder, based on the total weight of the molding composition. Within this limit, the semicrystalline poly(2,6-dimethyl-1,4-phenylene ether) powder content of the molding content can be at least 80 weight percent, at least 90 weight percent, at least 95 weight percent, or at least 98 weight percent, or at least 99 weight percent, or 100 weight percent. When the molding composition does not consist of the semicrystalline poly(2,6-dimethyl-1,4-phenylene ether) powder, it can further comprise 1 to 50 weight percent of fillers, including reinforcing agents, and/or 1 to 20 weight percent of additives, based on the total weight of the molding composition.

Suitable fillers and reinforcing agents include, for example, silicates and silica powders such as aluminum silicate (mullite), synthetic calcium silicate, zirconium silicate, fused silica, crystalline silica graphite, and natural silica sand; boron powders such as boron-nitride powder, and boron-silicate powders; oxides such as TiO₂, aluminum oxide, and magnesium oxide; calcium sulfate (as its anhydride, dihydrate or trihydrate); calcium carbonates such as chalk, limestone, marble, and synthetic precipitated calcium carbonates; talc, including fibrous, modular, needle shaped, and lamellar talc; wollastonite; surface-treated wollastonite; glass spheres such as hollow and solid glass spheres, silicate spheres, cenospheres, and aluminosilicate spheres; kaolin, including hard kaolin, soft kaolin, and calcined kaolin; single crystal fibers or “whiskers” such as silicon carbide fibers, alumina fibers, boron carbide fibers, iron fibers, nickel fibers, and copper fibers; other fibers, including continuous and chopped fibers, such as carbon fibers, glass fibers, such as E, A, C, ECR, R, S, D, and NE glasses; sulfides such as molybdenum sulfide, and zinc sulfide; barium compounds such as barium titanate, barium ferrite, barium sulfate, and heavy spar; metals and metal oxides such as particulate or fibrous aluminum, bronze, zinc, copper and nickel; flaked fillers such as glass flakes, flaked silicon carbide, aluminum diboride, aluminum flakes, and steel flakes; fibers such as those derived from blends comprising at least one of aluminum silicates, aluminum oxides, magnesium oxides, and calcium sulfate hemihydrate; natural fillers and reinforcements, such as wood flour obtained by pulverizing wood, fibrous products such as cellulose, cotton, sisal, jute, starch, cork flour, lignin, ground nut shells, corn, rice and grain husks; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, and poly(vinyl alcohol); as well as additional fillers and reinforcing agents such as mica, clay, feldspar, flue dust, fillite, quartz, quartzite, perlite, tripoli, diatomaceous earth, and carbon black; or combinations thereof.

Suitable additives include, for example, stabilizers, mold release agents, lubricants, processing aids, nucleating agents, UV blockers, dyes, pigments, antioxidants, antistatic agents, metal deactivators, and combinations thereof.

After the molding composition is added to a cavity of a compression mold, the composition is compressed to form the article. During compression, the pressure can be 1 to 500 megapascals. Within this range, the pressure can be 5 to 100 megapascals, or 5 to 50 megapascals. Also during compression, the temperature can be 125° C. to a temperature 5° C. less than the glass transition temperature of the semicrystalline poly(2,6-dimethyl-1,4-phenylene ether) powder. Within this range, the temperature can be 125 to 210° C., or 140 to 190° C., or 150 to 180° C. Molding can be conducted for 1 to 60 minutes. Within this range, the molding time can be 1 to 30 minutes, or 2 to 20 minutes.

In some embodiments, molding increases the crystallinity of the poly(2,6-dimethyl-1,4-phenylene ether). Specifically, in these embodiments the molded article comprises poly(2,6-dimethyl-1,4-phenylene ether) having a crystallinity greater than that of the semicrystalline poly(2,6-dimethyl-1,4-phenylene ether) powder. For example, the poly(2,6-dimethyl-1,4-phenylene ether) of the molded article can have a crystallinity at least 5 weight percent greater than the crystallinity of the semicrystalline poly(2,6-dimethyl-1,4-phenylene ether) powder.

In some embodiments, the poly(2,6-dimethyl-1,4-phenylene ether) of the molded article has a crystallinity of at least 5 weight percent, based on the weight of the poly(2,6-dimethyl-1,4-phenylene ether) in the article. Within this limit, the crystallinity can be 5 to 95 weight percent, or 10 to 50 weight percent, or 15 to 50 weight percent, or 20 to 50 weight percent.

Once molding is completed, the article can be removed from the cavity. Extended cooling times are not required before such removal. For example, the article can be removed from the cavity when the article's surface temperature is within 10° C. of the molding (compression) temperature. The article's surface temperature can be determined by contact or non-contact (e.g., infrared) methods known in the art.

In a very specific embodiment of the method, the semicrystalline poly(2,6-dimethyl-1,4-phenylene ether) powder has a crystallinity of 2 to 10 weight percent, compressing is conducted for a period of 1 to 20 minutes, the compression temperature is 140 to 190° C., and the compression pressure is 5 to 50 megapascals.

The method can be used to mold a variety of useful articles, including gears, cams, filters, tiles, brackets, grills, panels (including flat panels and curved panels), bearings, bushings, bearing caps, rotors, sprockets, thrust plates, pulleys (including timing pulleys), synchronizer hubs, piston rings, fuel injection components, shock absorber components, valve train components, and casings for consumer electronics (including casings for laptops, tablets, and smart phones).

In some embodiments, the article comprises poly(2,6-dimethyl-1,4-phenylene ether) having a crystallinity of at least 5 weight percent, based on the weight of the poly(2,6-dimethyl-1,4-phenylene ether) in the article. Within this limit, the crystallinity can be 5 to 95 weight percent, or 10 to 50 weight percent, or 15 to 50 weight percent, or 20 to 50 weight percent.

Another embodiment is an article comprising a composition comprising, based on the weight of the composition, 95 to 100 weight percent of poly(2,6-dimethyl-1,4-phenylene ether), and 0 to 5 weight percent of an additive selected from the group consisting of stabilizers, mold release agents, lubricants, processing aids, nucleating agents, UV blockers, dyes, pigments, antioxidants, antistatic agents, metal deactivators, and combinations thereof; wherein the poly(2,6-dimethyl-1,4-phenylene ether) has a crystallinity of at least 5 weight percent, based on the weight of the poly(2,6-dimethyl-1,4-phenylene ether). Within this crystallinity limitation of at least 5 weight percent, the crystallinity can be 5 to 50 weight percent, or 10 to 50 weight percent, or 15 to 50 weight percent, or 20 to 50 weight percent. This article can take the form of any of the article types mentioned above.

Another embodiment is a method of increasing the crystallinity of a poly(2,6-dimethyl-1,4-phenylene ether), the method comprising: exposing a poly(2,6-dimethyl-1,4-phenylene ether) to a temperature of 130 to 200° C. and a pressure of 1 to 500 megapascals for a time of 1 to 60 minutes; wherein prior to said exposing, the poly(2,6-dimethyl-1,4-phenylene ether) has a crystallinity of at least 1 weight percent.

In a very specific embodiment of the method, prior to said exposing the poly(2,6-dimethyl-1,4-phenylene ether) has a crystallinity of 2 to 10 weight percent; and said exposing is conducted for a time of 1 to 20 minutes, at a temperature of 140 to 190° C., and at a pressure of 5 to 50 megapascals.

The invention includes at least the following embodiments.

### Embodiment 1

A method of forming an article, comprising: adding a molding composition comprising a semicrystalline poly(2,6-dimethyl-1,4-phenylene ether) powder to a cavity of a compression mold; wherein the semicrystalline poly(2,6-dimethyl-1,4-phenylene ether) powder has a crystallinity of at least 1 weight percent based on the total weight of the semicrystalline poly(2,6-dimethyl-1,4-phenylene ether) powder, and a glass transition temperature of 205 to 225° C.; and compressing the molding composition in the cavity at a compression temperature and a compression pressure for a period of 1 to 60 minutes to form the article; wherein the compression temperature is 130° C. to a temperature 5° C. less than the glass transition temperature of the semicrystalline poly(2,6-dimethyl-1,4-phenylene ether) powder; and wherein the compression pressure is 1 to 500 megapascals.

### Embodiment 2

The method of embodiment 1, wherein the molding composition comprises at least 95 weight percent of the semicrystalline poly(2,6-dimethyl-1,4-phenylene ether) powder, based on the total weight of the molding composition.

### Embodiment 3

The method of embodiment 1 or 2, wherein the semicrystalline poly(2,6-dimethyl-1,4-phenylene ether) powder has an intrinsic viscosity of 0.2 to 1.0 deciliter/gram, measured at 25° C. in chloroform.

### Embodiment 4

The method of any one of embodiments 1-3, wherein the semicrystalline poly(2,6-dimethyl-1,4-phenylene ether) powder has a number-average mean particle size of 0.5 to 800 micrometers.

### Embodiment 5

The method of any one of embodiments 1-4, wherein the semicrystalline poly(2,6-dimethyl-1,4-phenylene ether) powder has a crystallinity of 1 to 30 weight percent.

### Embodiment 6

The method of any one of embodiments 1-5, wherein the compression temperature is 125 to 210° C.

### Embodiment 7

The method of any one of embodiments 1-6, wherein the article comprises poly(2,6-dimethyl-1,4-phenylene ether) having a crystallinity greater than that of the semicrystalline poly(2,6-dimethyl-1,4-phenylene ether) powder.

### Embodiment 8

The method of any one of embodiments 1-7, wherein the article comprises poly(2,6-dimethyl-1,4-phenylene ether) having a crystallinity at least 5 weight percent greater than the crystallinity of the semicrystalline poly(2,6-dimethyl-1,4-phenylene ether) powder.

### Embodiment 9

The method of any one of embodiments 1-7, wherein the article comprises poly(2,6-dimethyl-1,4-phenylene ether) having a crystallinity of at least 5 weight percent, based on the weight of the semicrystalline poly(2,6-dimethyl-1,4-phenylene ether) in the article.

### Embodiment 10

The method of any one of embodiments 1-9, further comprising removing the article from the cavity, wherein when the article is removed from the cavity, it has a surface temperature within 10° C. of the compression temperature.

### Embodiment 11

The method of any one of embodiments 1-10, wherein the article is selected from the group consisting of gears, cams, filters, tiles, brackets, grills, panels, bearings, bushings, bearing caps, rotors, sprockets, thrust plates, pulleys, synchronizer hubs, piston rings, fuel injection components, shock absorber components, valve train components, and casings for consumer electronics.

### Embodiment 12

The method of embodiment 1, wherein the semicrystalline poly(2,6-dimethyl-1,4-phenylene ether) powder has a crystallinity of 2 to 10 weight percent; wherein said compressing is conducted for a period of 1 to 20 minutes; wherein the compression temperature is 140 to 190° C.; and wherein the compression pressure is 5 to 50 megapascals.

### Embodiment 13

An article formed by the method of any one of embodiments 1-12.

### Embodiment 14

The article of embodiment 13, wherein the article is selected from the group consisting of gears, cams, filters, tiles, brackets, grills, panels, bearings, bushings, bearing caps, rotors, sprockets, thrust plates, pulleys, synchronizer hubs, piston rings, fuel injection components, shock absorber components, valve train components, and casings for consumer electronics.

### Embodiment 15

The article of embodiment 13 or 14, comprising poly(2,6-dimethyl-1,4-phenylene ether) having a crystallinity of at least 5 weight percent, based on the weight of the poly(2,6-dimethyl-1,4-phenylene ether) in the article.

### Embodiment 16

An article comprising a composition comprising, based on the weight of the composition, 95 to 100 weight percent of poly(2,6-dimethyl-1,4-phenylene ether), and 0 to 5 weight percent of an additive selected from the group consisting of stabilizers, mold release agents, lubricants, processing aids, nucleating agents, UV blockers, dyes, pigments, antioxidants, antistatic agents, metal deactivators, and combinations thereof; wherein the poly(2,6-dimethyl-1,4-phenylene ether) has a crystallinity of at least 5 weight percent, based on the weight of the poly(2,6-dimethyl-1,4-phenylene ether).

### Embodiment 17

The article of embodiment 16, wherein the article is selected from the group consisting of gears, cams, filters, tiles, brackets, grills, panels, bearings, bushings, bearing caps, rotors, sprockets, thrust plates, pulleys, synchronizer hubs, piston rings, fuel injection components, shock absorber components, valve train components, and casings for consumer electronics.

### Embodiment 18

A method of increasing the crystallinity of a poly(2,6-dimethyl-1,4-phenylene ether), the method comprising: exposing a poly(2,6-dimethyl-1,4-phenylene ether) to a temperature of 130 to 200° C. and a pressure of 1 to 500 megapascals for a time of 1 to 60 minutes; wherein prior to said exposing, the poly(2,6-dimethyl-1,4-phenylene ether) has a crystallinity of at least 1 weight percent.

### Embodiment 19

The method of embodiment 18, wherein prior to said exposing, the poly(2,6-dimethyl-1,4-phenylene ether) has a crystallinity of 2 to 10 weight percent; and wherein said exposing is conducted for a time of 1 to 20 minutes, at a temperature of 140 to 190° C., and at a pressure of 5 to 50 megapascals.

All ranges disclosed herein are inclusive of the endpoints, and the endpoints are independently combinable with each other. Each range disclosed herein constitutes a disclosure of any point or sub-range lying within the disclosed range.

The invention is further illustrated by the following non-limiting examples.

### Examples

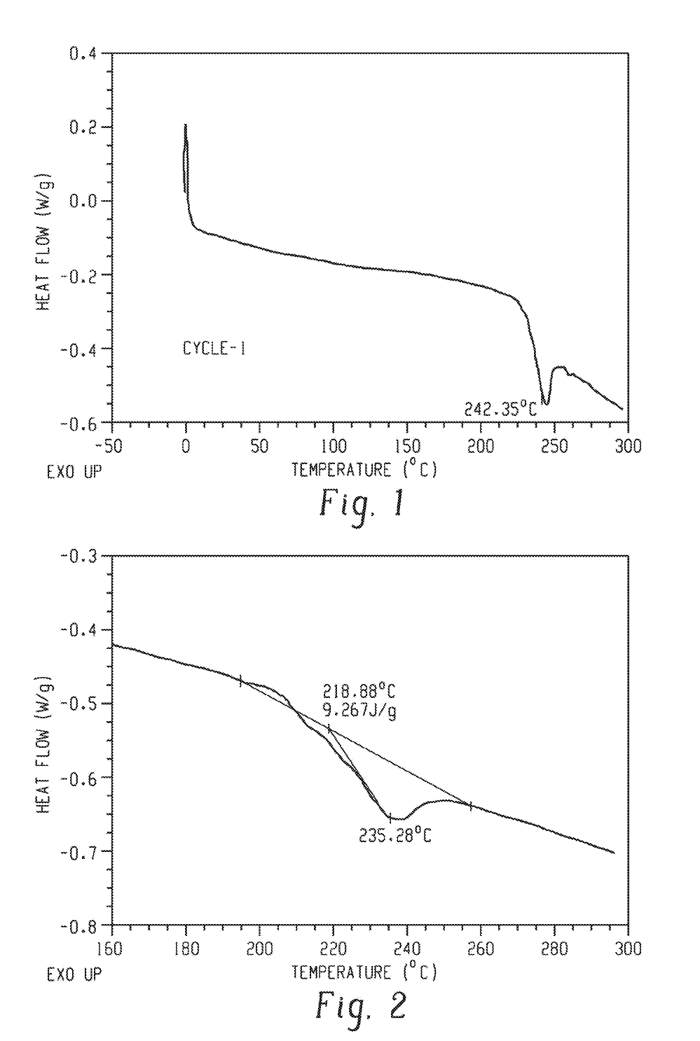

Poly(2,6-dimethyl-1,4-phenylene ether) having an intrinsic viscosity of about 0.46 deciliter per gram, measured by Ubbelohde viscometer at 25° C. in chloroform, was obtained as PPO™ 803 Resin from SABIC. The poly(2,6-dimethyl-1,4-phenylene ether) was used in powder form. It had a glass transition temperature of 215° C., a melting temperature of 235° C., and a crystallinity of 20 weight percent, all determined by differential scanning calorimetry (DSC) using a temperature range of 0 to 280° C. and a heating rate of 10° C. per minute. A DSC thermogram for the as-received poly(2,6-dimethyl-1,4-phenylene ether) powder is presented as FIG. 1.

For compression molding experiments, 10 grams of poly(2,6-dimethyl-1,4-phenylene ether) powder were placed in a capillary rheometer and compacted at the chosen temperature, a pressure of 10 megapascals, and a time of ten minutes. The compression temperature was 100, 120, 150, 170, or 240° C. The rheometer barrel was 15 millimeters in diameter and was well insulated. During molding, the rheometer's piston compacted the powder into a cylinder 15 millimeters in diameter and about 5 centimeters in length. After compaction, and the compacted cylinder was ejected without cooling, at the compression temperature, by driving down the piston. The only exception was the sample prepared at a compression temperature of 240° C. (above Tₘ), which was cooled to before ejection.

The compacted cylinder formed at 100° C. (below T_{g} and Tₘ) was powdery to the touch on both the exterior surface an interior cross-section surface. The cylinder was under-consolidated as evidenced by its breaking easily when dropped onto a ceramic floor from a height of 1.75 meters.

The compacted cylinder formed at 120° C. (below T_{g} and Tₘ) was less powdery to the touch than the 100° C. sample, but still somewhat powdery on both the exterior surface an interior cross-section. The cylinder was under-consolidated as evidenced by its breaking easily into three pieces when dropped onto a ceramic floor from a height of 1.75 meters.

The compacted cylinder formed at 150° C. (below T_{g} and Tₘ) was not powdery on its exterior or interior surface (the interior surface having been exposed by cutting the cylinder with a band saw). The cylinder was well consolidated based on its remaining intact when dropped onto a ceramic floor from a height of 1.75 meters, and its poly(2,6-dimethyl-1,4-phenylene ether) exhibited a crystallinity of 20 weight percent, as determined by DSC. A DSC thermogram for poly(2,6-dimethyl-1,4-phenylene ether) from the cylinder formed at 150° C. is presented as FIG. 2.

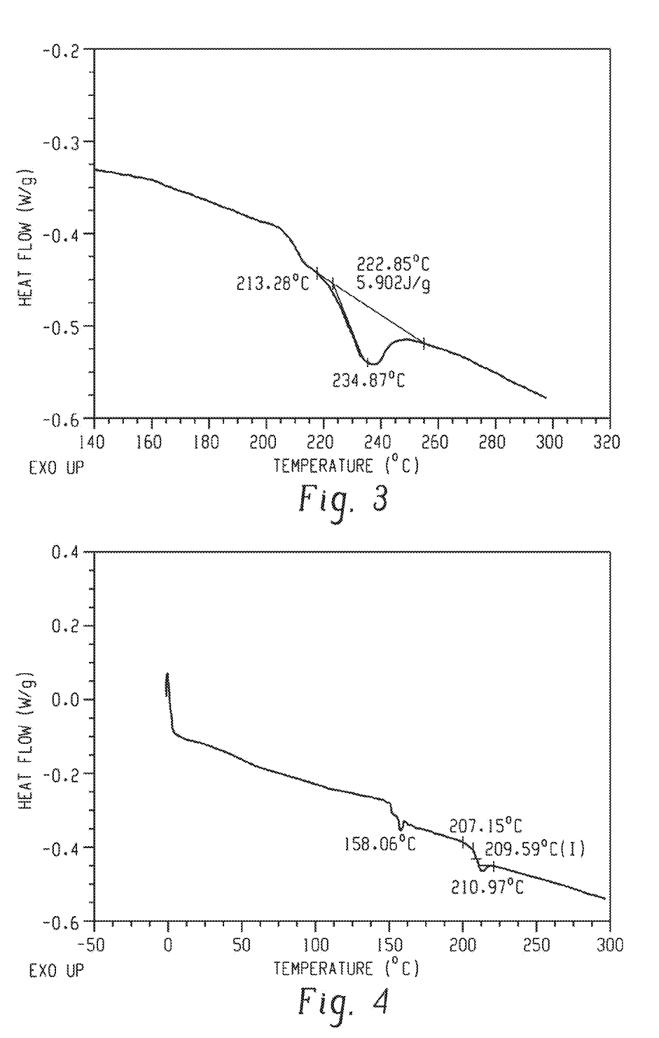

The compacted cylinder formed at 170° C. (below T_{g} and Tₘ) exhibited no powder grains or voids on exterior or interior (band saw cut) surfaces. The cylinder was well consolidated based on its remaining intact when dropped onto a ceramic floor from a height of 1.75 meters, and its poly(2,6-dimethyl-1,4-phenylene ether) exhibited a crystallinity of 10 weight percent, as determined by DSC. A DSC thermogram for poly(2,6-dimethyl-1,4-phenylene ether) from the cylinder formed at 170° C. is presented as FIG. 3.

The compacted cylinder formed at 240° C. (above T_{g} and Tₘ) was amber colored and translucent. A DSC thermogram for poly(2,6-dimethyl-1,4-phenylene ether) from the cylinder formed at 240° C. is presented as FIG. 4. The thermogram shows no evidence of a melting point, indicating that any crystallinity in the starting poly(2,6-dimethyl-1,4-phenylene ether) powder melted on heating above Tₘ but did not recrystallize on cooling. In the thermogram, the glass transition temperature is observed at about 211° C.

1. A method of forming an article, comprising:
adding a molding composition comprising a semicrystalline poly(2,6-dimethyl-1,4-phenylene ether) powder to a cavity of a compression mold; wherein the semicrystalline poly(2,6-dimethyl-1,4-phenylene ether) powder has a crystallinity of at least 1 weight percent based on the total weight of the semicrystalline poly(2,6-dimethyl-1,4-phenylene ether) powder, and a glass transition temperature of 205 to 225° C.; and
compressing the molding composition in the cavity at a compression temperature and a compression pressure for a period of 1 to 60 minutes to form the article; wherein the compression temperature is 130° C. to a temperature 5° C. less than the glass transition temperature of the semicrystalline poly(2,6-dimethyl-1,4-phenylene ether) powder; and wherein the compression pressure is 1 to 500 megapascals.

2. The method of claim 1, wherein the molding composition comprises at least 95 weight percent of the semicrystalline poly(2,6-dimethyl-1,4-phenylene ether) powder, based on the total weight of the molding composition.

3. The method of claim 1, wherein the semicrystalline poly(2,6-dimethyl-1,4-phenylene ether) powder has an intrinsic viscosity of 0.2 to 1.0 deciliter/gram, measured at 25° C. in chloroform.

4. The method of claim 1, wherein the semicrystalline poly(2,6-dimethyl-1,4-phenylene ether) powder has a number-average mean particle size of 0.5 to 800 micrometers.

5. The method of claim 1, wherein the semicrystalline poly(2,6-dimethyl-1,4-phenylene ether) powder has a crystallinity of 1 to 30 weight percent.

6. The method of claim 1, wherein the compression temperature is 125 to 210° C.

7. The method of claim 1, wherein the article comprises poly(2,6-dimethyl-1,4-phenylene ether) having a crystallinity greater than that of the semicrystalline poly(2,6-dimethyl-1,4-phenylene ether) powder.

8. The method of claim 1, wherein the article comprises poly(2,6-dimethyl-1,4-phenylene ether) having a crystallinity at least 5 weight percent greater than the crystallinity of the semicrystalline poly(2,6-dimethyl-1,4-phenylene ether) powder.

9. The method of claim 1, wherein the article comprises poly(2,6-dimethyl-1,4-phenylene ether) having a crystallinity of at least 5 weight percent, based on the weight of the semicrystalline poly(2,6-dimethyl-1,4-phenylene ether) in the article.

10. The method of claim 1, further comprising removing the article from the cavity, wherein when the article is removed from the cavity, it has a surface temperature within 10° C. of the compression temperature.

11. The method of claim 1, wherein the article is selected from the group consisting of gears, cams, filters, tiles, brackets, grills, panels, bearings, bushings, bearing caps, rotors, sprockets, thrust plates, pulleys, synchronizer hubs, piston rings, fuel injection components, shock absorber components, valve train components, and casings for consumer electronics.

12. The method of claim 1,
wherein the semicrystalline poly(2,6-dimethyl-1,4-phenylene ether) powder has a crystallinity of 2 to 10 weight percent;
wherein said compressing is conducted for a period of 1 to 20 minutes;
wherein the compression temperature is 140 to 190° C.; and
wherein the compression pressure is 5 to 50 megapascals.

13. An article formed by the method of claim 1.

14. The article of claim 13, wherein the article is selected from the group consisting of gears, cams, filters, tiles, brackets, grills, panels, bearings, bushings, bearing caps, rotors, sprockets, thrust plates, pulleys, synchronizer hubs, piston rings, fuel injection components, shock absorber components, valve train components, and casings for consumer electronics.

15. The article of claim 13, comprising poly(2,6-dimethyl-1,4-phenylene ether) having a crystallinity of at least 5 weight percent, based on the weight of the poly(2,6-dimethyl-1,4-phenylene ether) in the article.

16. An article comprising a composition comprising, based on the weight of the composition, 95 to 100 weight percent of poly(2,6-dimethyl-1,4-phenylene ether), and 0 to 5 weight percent of an additive selected from the group consisting of stabilizers, mold release agents, lubricants, processing aids, nucleating agents, UV blockers, dyes, pigments, antioxidants, antistatic agents, metal deactivators, and combinations thereof; wherein the poly(2,6-dimethyl-1,4-phenylene ether) has a crystallinity of at least 5 weight percent, based on the weight of the poly(2,6-dimethyl-1,4-phenylene ether).

17. The article of claim 16, wherein the article is selected from the group consisting of gears, cams, filters, tiles, brackets, grills, panels, bearings, bushings, bearing caps, rotors, sprockets, thrust plates, pulleys, synchronizer hubs, piston rings, fuel injection components, shock absorber components, valve train components, and casings for consumer electronics.

18. A method of increasing the crystallinity of a poly(2,6-dimethyl-1,4-phenylene ether), the method comprising:
exposing a poly(2,6-dimethyl-1,4-phenylene ether) to a temperature of 130 to 200° C. and a pressure of 1 to 500 megapascals for a time of 1 to 60 minutes;
wherein prior to said exposing, the poly(2,6-dimethyl-1,4-phenylene ether) has a crystallinity of at least 1 weight percent.

19. The method of claim 18,
wherein prior to said exposing, the poly(2,6-dimethyl-1,4-phenylene ether) has a crystallinity of 2 to 10 weight percent; and
wherein said exposing is conducted
for a time of 1 to 20 minutes,
at a temperature of 140 to 190° C., and
at a pressure of 5 to 50 megapascals.
